(19) United States
(12) Patent Application Publication
(10) Pub. No.: US 2026/0077692 A1
(43) Pub. Date: Mar. 19, 2026

(54) VEHICLE SEAT

(71) Applicant: TACHI-S CO., LTD., Tokyo (JP)

(72) Inventors: Masanobu Mukuta, Tokyo (JP); Yousuke Noguchi, Tokyo (JP); Ryou Kurobe, Tokyo (JP); Ryouta Tomioka, Tokyo (JP)

(73) Assignee: TACHI-S CO., LTD., Tokyo (JP)

(21) Appl. No.: 19/324,644

(22) Filed: Sep. 10, 2025

(30) Foreign Application Priority Data
Sep. 16, 2024 (JP) 2024-159668

(51) Int. Cl. B60N 2/68

(52) U.S. Cl. CPC B60N 2/686

(57) ABSTRACT

A vehicle seat for improving the workability of installation work of a side finisher is provided. Since displacement of the side finisher in up-down and left-right directions is restricted with a guide projection engaged with a guide hole (with the guide projection slid to the end position), relative positions between the claws and the fitting holes can be generally determined by the guide projection being slid to the rear side along the guide hole. In contrast, since the claws and the fitting holes are not formed on the front side of the guide projection, relative positions between these fitting portions only need to be adjusted only on the rear side of the guide projection. Since this can facilitate the fitting of the claws into the fitting holes while adjusting relative positions between the claws and the fitting holes, the workability of installation work of the side finisher can be improved.

### BACKGROUND OF THE INVENTION

### 1. Field of the Invention

The present invention relates to a vehicle seat and, more particularly, to a vehicle seat capable of improving the workability of installation work of a side finisher.

### 2. Description of the Related Art

For example, Japanese Unexamined Patent Application Publication No. 2013-001149 (for example, paragraphs 0018 to 0020 and FIG. 1) describes a technique for covering the side surface of a side frame 31 of a vehicle seat with a side shield member 50. Clips 75 and 76 provided in the side shield member 50 are fitted into boss portions 37a and 37b of the side frame 31 from the lateral side, and accordingly, the side shield member 50 is attached to the side frame 31.

### SUMMARY OF THE INVENTION

When the side shield member 50 is attached to the side frame 31, the positions of the boss portions 37a and 37b are obstructed by the side shield member 50 and become difficult to see, and accordingly, considerable effort is required for the work of adjusting the relative positions between the boss portions 37a and 37b and the clips 75 and 76. In particular, in Patent Document 1, since the boss portions 37a and 37b (clips 75 and 76) are formed at two positions spaced apart from each other in the front-rear direction, considerable effort is required for the work of fitting the boss portions 37a and 37b and the clips 75 and 76 together while adjusting the relative positions therebetween. Accordingly, there is a problem with poor workability of installation work of the side shield member 50 (side finisher).

The present invention addresses the problem described above with an object of providing a vehicle seat capable of improving the workability of installation work of the side finisher.

To achieve the object, according to the present invention, there is provided a vehicle seat including: a side frame, provided in a cushion frame, that extends in a front-rear direction; and a side finisher that covers a side surface of the side frame, in which a side closer to the side frame includes a fitting portion, the side finisher includes a fitting portion, and the fitting portions are fitted to each other by the side finisher being pushed from a lateral side, the side closer to the side frame has a guide hole on a front side of the fitting portion, the side finisher includes a guide projection fitted to the guide hole in a slidable manner from the front side, displacement of the side finisher in an up-down direction and in a left-right direction is restricted with the guide projection engaged with the guide hole, and the fitting portion is not formed on the front side of the guide projection.

According to a vehicle seat according to a first aspect, the side closer to the side frame has a guide hole on the front side of the fitting portion, and the side finisher includes a guide projection to be slidably engaged with the guide hole from the front side. Since the displacement of the side finisher in the up-down direction and in the left-right direction is restricted with the guide projection engaged with the guide hole (with the guide projection slid to the end position), the relative position between the fitting portions of the side closer to the side frame and the side finisher can be generally determined by the guide projection being slid to the rear side along the guide hole.

On the other hand, since the fitting portions are not formed on the front side of the guide projection, the relative position between the fitting portions only needs to be adjusted only on the rear side of the guide projection. Since this facilitates the work of fitting the fitting portions together while adjusting the relative position therebetween, there is the effect of improving the workability of installation work of the side finisher.

In a vehicle seat according to a second aspect, in addition to the effect achieved by the vehicle seat according to the first aspect, the following effect is achieved. The side closer to the side-frame side has an insertion portion that projects toward the front side, and the side finisher has an insertion hole, formed on the front side of the guide projection, that has an opening on the rear side into which the insertion portion is inserted. Since the displacement of the side finisher in the up-down direction and in the left-right direction is restricted with the insertion portion inserted into the insertion hole, the displacement of the side finisher in these directions can be restricted by two points spaced apart in the front-rear direction, which are the guide projection and the insertion hole. Accordingly, the side finisher can be stably fixed to the side frame.

In addition, the insertion of the insertion portion into the insertion hole only needs to be performed in the front-rear direction, and insertion from the lateral side as when the guide projection is engaged with the guide hole is unnecessary. Accordingly, the mounting position of the side finisher can be adjusted more easily than the case in which a projection corresponding to the guide projection is provided at the front-end portion of the side finisher instead of the insertion hole. Accordingly, there is the effect of improving the workability of installation work of the side finisher.

In a vehicle seat according to a third aspect, in addition to the effect achieved by the vehicle seat according to the second aspect, the side finisher includes a guide wall portion, formed in a rib shape extending rearward from the rear end portion of the insertion hole, that is inclined away from the insertion portion toward the rear side, and accordingly, the insertion of the insertion portion into the insertion hole can be guided by the guide wall portion. Since this can eliminate the work of adjusting the relative position between the insertion hole and the insertion portion when the side finisher is slid to the rear side, there is the effect of improving the workability of installation work of the side finisher.

In a vehicle seat according to a fourth aspect, in addition to the effect achieved by the vehicle seat according to the first aspect, the guide hole has a receptacle opening that is larger than the outer shape of the guide projection, a tapered portion, continuous with a portion rearward of the receptacle opening, that has an opening dimension in the up-down direction gradually reducing toward the rear side, and an engagement portion, continuous with a portion rearward of the tapered portion, with which the guide projection is engaged, and accordingly, when the guide projection inserted into the receptacle opening is slid toward the engagement portion, the sliding can be guided by the tapered portion. That is, after the guide projection is inserted into the receptacle opening, the guide projection can be engaged with the engagement portion only by the side finisher being moved to the rear side. Accordingly, there is the effect of improving the workability of installation work of the side finisher.

In a vehicle seat according to a fifth aspect, in addition to the effect achieved by the vehicle seat according to the fourth aspect, the following effect is achieved. Since the guide projection includes a base portion to be engaged with the engagement portion and a projecting portion that projects upward from the end portion of the base portion on the inside in the left-right direction, when a load from the occupant acts on the upper surface portion of the side finisher, the projecting portion can effectively restrict the side finisher from bending (spreading) to the lateral downside. Accordingly, there is the effect of stably fixing the side finisher to the side frame.

In a vehicle seat according to a sixth aspect, in addition to the effect achieved by the vehicle seat according to the fifth aspect, the following effect is achieved. Since the projecting portion extends upward and rearward from the end portion of the base portion on the inside in the left-right direction, and the outer shape of the projecting portion corresponds to the receptacle opening and the tapered portion, the projecting portion can be formed in a shape that can be inserted into the guide hole (the receptacle opening and the tapered portion) while the amount of projection of the projecting portion toward the rear side is increased. The increase in the amount of projection of the projecting portion toward the rear side can improve the bending strength of the projecting portion with respect to the base portion as compared the structure in which, for example, the projecting portion projects only upward from the base portion. Accordingly, even when a load from the occupant repeatedly acts on the upper surface portion of the side finisher, there is the effect of suppressing the guide projection (projecting portion) from being broken.

In a vehicle seat according to a seventh aspect, in addition to the effect achieved by the vehicle seat according to the first aspect, the following effect is achieved. The side finisher includes a covering portion that covers the side surface of the side frame and an outer peripheral portion that rises from the outer edge of the covering portion toward the side frame, and the outer peripheral portion includes a back surface portion that covers other components disposed inside the side frame from the rear side.

Since a restricting wall that restricts the deformation of the side finisher toward the other components is formed on the back surface portion, even when a load from the rear side acts on the side finisher, movement and deformation (bending) of the side finisher toward the front side can be restricted by the contact between the restricting wall and the other components. Accordingly, there is the effect of suppressing the detachment of the side finisher from the side frame or the breakage of the side finisher.

In a vehicle seat according to an eighth aspect, in addition to the effect provided by the vehicle seat according to the seventh aspect, the side finisher includes a plurality of fitting portions arranged along the back surface portion and restricting walls formed between the plurality of fitting portions, and accordingly, when a load from the rear side acts on the side finisher, the contact between the fitting portions and the other components can be restricted by the restricting wall. As a result, there is the effect of suppressing the detachment of the fitting portions and the breakage of the fitting portions.

In a vehicle seat according to a ninth aspect, in addition to the effect achieved by the vehicle seat according to the second aspect, the following effect is achieved. The insertion hole has an outer-wall portion formed on a side surface of the side finisher on the inside in the left-right direction, an upper-wall portion and a lower-wall portion that project to the inside in the left-right direction from both ends of the outer-wall portion in the up-down direction, and an inner-wall portion that connects, in the up-down direction, the end portions of the upper-wall portion and the lower-wall portion on the inside in the left-right direction, and the inner-wall portion has rib portions that project toward the outer-wall portion. Since the rib portions are formed like walls that extend in the front-rear direction, and the plurality of rib portions are arranged in the up-down direction, the rigidity of the inner-wall portion can be enhanced by the rib portions. As a result, there is the effect of suppressing the insertion hole from being broken even when the insertion portion is pressed against the inner-wall portion by a load from the occupant.

In a vehicle seat according to a tenth aspect, in addition to the effect achieved by the vehicle seat according to the ninth aspect, the following effect is achieved. The insertion hole has a front-wall portion that brocks the front-end portion of the space surrounded by the outer-wall portion, the upper-wall portion, the lower-wall portion, and the inner-wall portion. Since the rib portions couple the inner-wall portion and the front-wall portion to each other, the front-wall portion can receive a portion of the load when the insertion portion is pressed against the inner-wall portion. Accordingly, there is the effect of suppressing the insertion hole from being broken.

### BRIEF DESCRIPTION OF THE DRAWINGS

FIG. 1 is a perspective view of a vehicle seat.

FIG. 2 is a perspective view of a side finisher.

FIG. 3A is a side view of a mounting bracket and a side finisher as viewed in the direction of arrow IIIa in FIG. 2.

FIG. 3B is a cross-sectional view of the side finisher taken along line IIIb-IIIb in FIG. 3A.

FIG. 3C is a cross-sectional view of the mounting bracket and the side finisher taken along line IIIc-IIIc in FIG. 3A.

FIG. 4A is a side view of the mounting bracket and the side finisher in the state in which the side finisher has been slid to the rear side from the state in FIG. 3A.

FIG. 4B is a cross-sectional view of the mounting bracket and the side finisher taken along line IVb-IVb in FIG. 4A.

FIG. 5A is a perspective view of the side finisher, illustrating portion Va in FIG. 2 in an enlarged manner.

FIG. 5B is a side view of the side finisher as viewed in the direction of arrow Vb in FIG. 5A.

### DESCRIPTION OF THE PREFERRED EMBODIMENTS

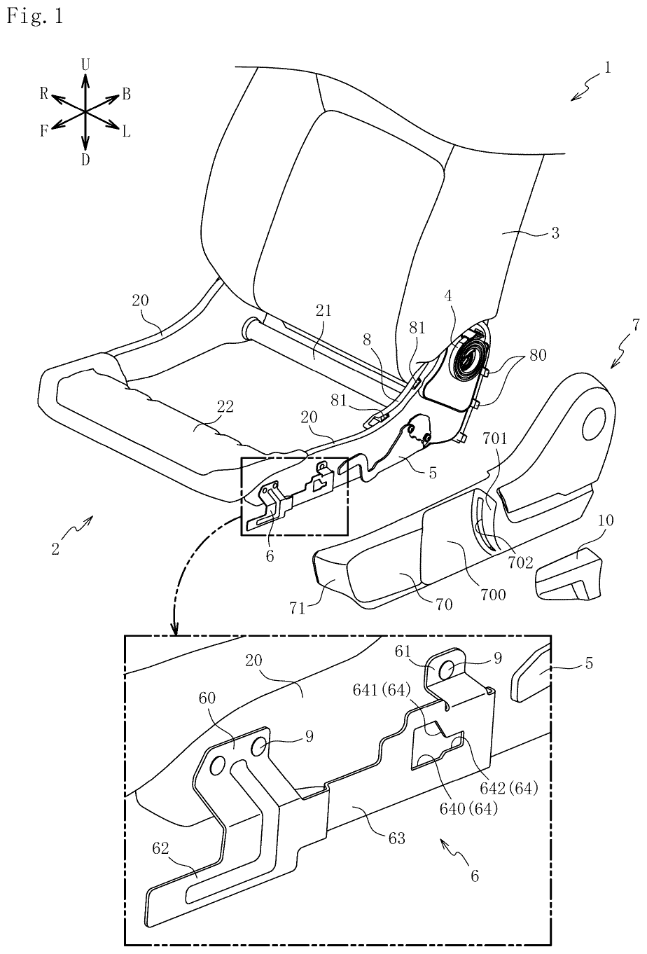

Preferred embodiments of the present invention will be described below with reference to the accompanying drawings. First, an overall structure of a vehicle seat 1 will be described with reference to FIG. 1. FIG. 1 is a perspective view of the vehicle seat 1. It should be noted that FIG. 1 illustrates a state in which a seat pad (cushion pad) supported by a cushion frame 2 and a covering skin that covers the seat pad have been removed. In addition, arrows U and D, arrows L and R, and arrows F and B in FIG. 1 indicate an up-down direction, a left-right direction, and a front-rear direction of the vehicle seat 1, respectively (the same applies to subsequent drawings).

As illustrated in FIG. 1, the vehicle seat 1 is a seat installed in a vehicle, such as an automobile, and includes a cushion frame 2 that forms the skeleton of a seat surface (seat cushion). A seat back 3 (back frame) is coupled to the rear end (the end portion on arrow B side) of the cushion frame 2 in a tiltable manner via a reclining device 4.

The cushion frame 2 includes a pair of side frames 20 that extend in front-rear direction (the direction of arrows F and B), and the side frames 20 have a space therebetween in the left-right direction (direction indicated by arrows L and R). Portions at the rear end side of the pair of side frames 20 are coupled to each other by a rear frame 21 that extends in the left-right direction, and portions at the front-end side thereof are coupled to each other by a front frame 22 (front panel) that extends in the left-right direction.

In the following description, the surface of the side frame 20 that faces the inside (the central side in the left-right direction of the cushion frame 2) in the left-right direction is referred to as the inner surface, and the side surface that faces the opposite side thereof is referred to as the outer surface (this also applies to other components of the vehicle seat 1). An operating lever 5 is attached to the outer surface of the side frame 20 rotatably about an axis along the left-right direction. The operating lever 5 according to the present embodiment is operated by the occupant to release the lock of the reclining device 4, but the operating lever 5 may also raise and lower the cushion frame 2.

The mounting bracket 6 is fixed to a portion of the outer surface of the side frame 20 that is located on the front side of the operating lever 5. The mounting bracket 6 is a component to which the side finisher 7 that covers the side surface of the side frame 20 is attached.

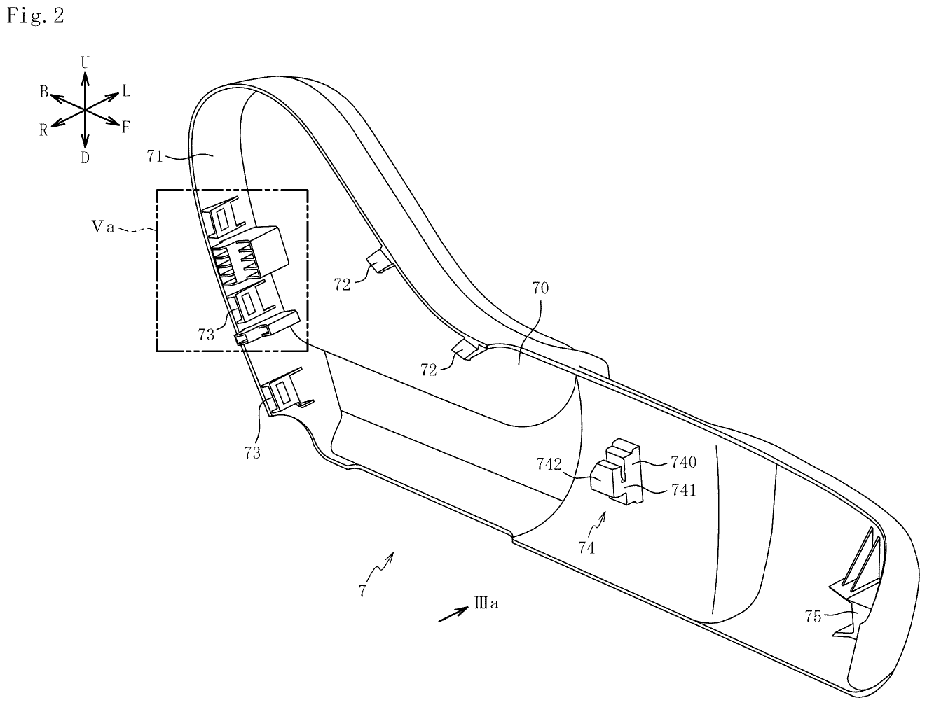

The mounting bracket 6 includes a first mounting portion 60 and a second mounting portion 61 that are spaced apart in the front-rear direction (see the enlarged portion in FIG. 1). These mounting portions 60 and 61 are fixed to the outer surface of the side frame 20 by fastening members 9, such as bolts or rivets. The mounting portions 60 and 61 are inclined downward toward the outside (arrow L side) in the left-right direction from the side frame 20, and an insertion portion 62 is formed below the first mounting portion 60 located on the front-end side of the mounting bracket 6. The insertion portion 62 projects to the front side beyond the first mounting portion 60, and this insertion portion 62 is inserted into an insertion hole 75 of the side finisher 7, which will be described later (see FIG. 2).

The mounting bracket 6 has a connection portion 63 that connects the lower end portion (insertion portion 62) of the first mounting portion 60 and the lower end portion of the second mounting portion 61 in the front-rear direction, and these portions 60 to 63 that constitute the mounting bracket 6 are formed integrally with each other by bending (pressing) a metal plate. That is, the portions 60 to 63 of the mounting bracket 6 are formed in a flat plate shape. A guide hole 64 that guides the attachment of the side finisher 7 is formed in the connection portion 63.

The guide hole 64 has a receptacle opening 640 with a substantially rectangular shape, a tapered portion 641, continuous with the rear end of the receptacle opening 640, that an opening dimension in the up-down direction gradually reducing toward the rear side, and an engagement portion 642, extending rearward from the rear end of the tapered portion 641, that has a substantially constant dimension in the up-down direction.

Next, the detailed structure of the side finisher 7 will be described with reference to FIGS. 1 and 2. FIG. 2 is a perspective view of the side finisher 7.

As illustrated in FIGS. 1 and 2, the side finisher 7 includes a covering portion 70 that extends in the front-rear direction (the direction of arrows F and B) and covers the outer surface of the side frame 20 and an outer peripheral portion 71 that rises from the outer edge of the covering portion 70 toward the side frame 20, and these components 70 and 71 are integrally formed of a resin material.

A recessed portion 700 (see FIG. 1) is provided in substantially the central portion in the front-rear direction of the outer surface of the covering portion 70. Since this recessed portion 700 is formed, a step surface 701 facing the front side is created on the outer surface of the covering portion 70, and an insertion hole 702 extending in the up-down direction is formed in the step surface 701 (see FIG. 1). The operating lever 5 is inserted into the insertion hole 702 that passes through this step surface 701.

It should be noted that the work of attaching the side finisher 7 to the mounting bracket 6 (engaging the guide projection 74 with the guide hole 64) is performed with the operating lever 5 inserted into the insertion hole 702. After the installation work is completed, a cover 10 is attached to the tip portion of the operating lever 5. The details of the installation procedure of the side finisher 7 will be described later.

The outer peripheral portion 71 of the side finisher 7 is formed like a wall that surrounds substantially the entire outer edge of the covering portion 70. A portion of the covering portion 70 close to the rear end (on the rear side of the insertion hole 702) is inclined upward toward the upper rear side, and the outer peripheral portion 71 that covers this inclined portion is formed integrally with claws 72 and fitting holes 73 (fitting portions) (see FIG. 2).

The claws 72 and the fitting holes 73 are formed along the inner peripheral surface of the outer peripheral portion 71, but some of the claws 72 and the fitting holes 73 are not illustrated for simplicity in FIG. 2. The claws 72 and the fitting holes 73 are used to fix the rear end portion of the side finisher 7 to the inner cover 8 (see FIG. 1) that covers the inner surface of the side frame 20.

The inner cover 8 is a resin component that covers the inner surface of the rear end side (reclining device 4) of the side frame 20, and claws 80 and fitting holes 81 (fitting portions) are formed integrally with the inner cover 8 at positions that correspond to the claws 72 and fitting holes 73 of the side finisher 7.

The claws 72 and 80 are fitted into the fitting holes 73 and 81 of the side finisher 7 and the inner cover 8, respectively, through elastic deformation thereof, and accordingly, the rear end portion of the side finisher 7 is fixed to the side frame 20 (inner cover 8). At this time, since the claws 72 and the fitting holes 73 are formed along the inner peripheral surface of the outer peripheral portion 71, the visibility of the claws 72 and 80 and the fitting holes 73 and 81 are less likely to be obstructed by the side finisher 7. This can facilitate the work of fitting the claws 72 and 80 into the fitting holes 73 and 81 while adjusting the relative positions therebetween.

On the other hand, the portion of the side finisher 7 closer to the front-end side (on the front side of the insertion hole 702) is fixed to the mounting bracket 6 by using the guide projection 74 and the insertion hole 75 (both see FIG. 2). The guide projection 74 and the insertion hole 75 are formed integrally with the inner surface of the covering portion 70.

The guide projection 74 includes a substantially rectangular parallelepiped pedestal portion 740 formed on the inner surface of the covering portion 70 so as to project, a base portion 741 that projects to the inside (arrow R side) in the left-right direction from the pedestal portion 740, and a projecting portion 742 that projects vertically from the end portion of the base portion 741 on the inside in the left-right direction, and these portions 740 to 742 are formed integrally with each other.

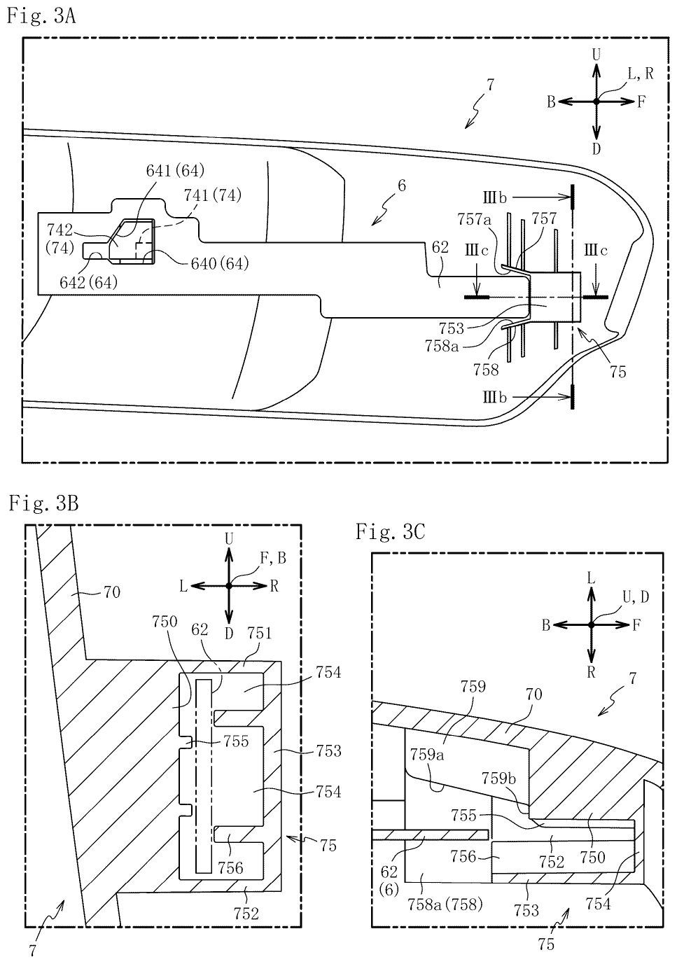

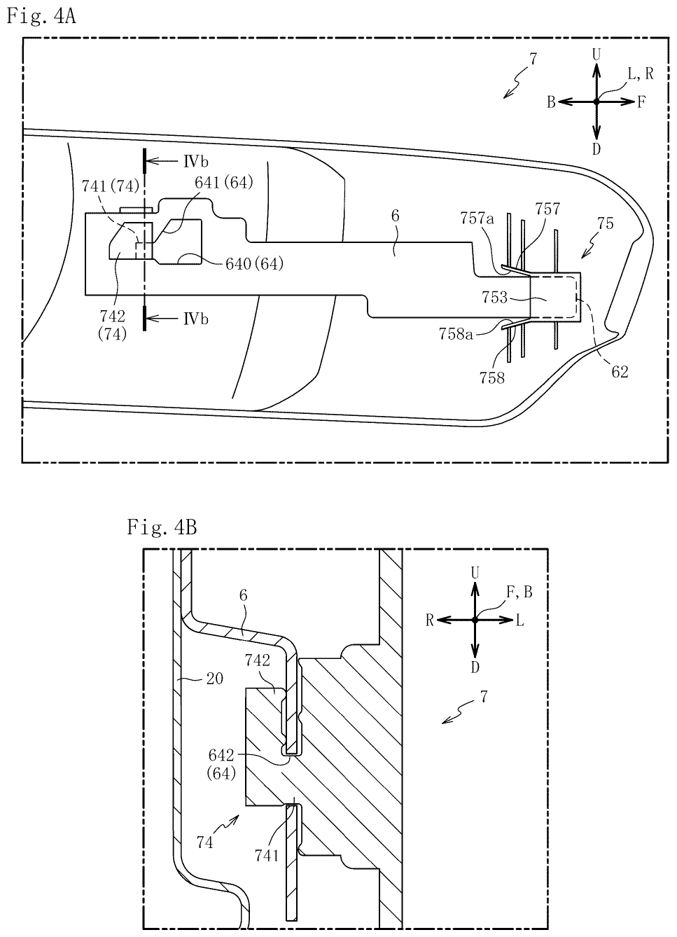

Next, the detailed structure of the side finisher 7 and the method of attachment to the mounting bracket 6 will be described with reference to FIGS. 3 and 4. FIG. 3A is a side view of the mounting bracket 6 and the side finisher 7 as viewed in the direction of arrow IIIa in FIG. 2, FIG. 3B is a cross-sectional view of the side finisher 7 taken along line IIIb-IIIb in FIG. 3A, and FIG. 3C is a cross-sectional view of the mounting bracket 6 and the side finisher 7 taken along line IIIc-IIIc of FIG. 3A.

FIG. 4A is a side view of the mounting bracket 6 and the side finisher 7 in the state in which the side finisher 7 has been slid to the rear side (arrow B side) from the state in FIG. 3A, and FIG. 4B is a cross-sectional view of the mounting bracket 6 and the side finisher 7 taken along line IVb-IVb in FIG. 4A.

It should be noted that FIGS. 3A and 4A illustrate the outer shape of the mounting bracket 6 excluding the mounting portions 60 and 61 (see FIG. 1). In addition, FIG. 3A illustrates the state before the insertion portion 62 of the mounting bracket 6 is inserted into the insertion hole 75, and FIG. 3B illustrates the outer shape of the insertion portion 62 after the insertion portion 62 is inserted into the insertion hole 75 by using a dot-dot-dash line. In addition, FIG. 4B is an end face view illustrating only a cross section of the side frame 20, the mounting bracket 6, and the side finisher 7.

As illustrated in FIG. 3, the insertion hole 75 of the side finisher 7 has an outer-wall portion 750 (see FIG. 3B or 3C) that rises from the inner surface of the covering portion 70, and an upper-wall portion 751 and a lower-wall portion 752 project toward the inside (arrow R side) in the left-right direction from the upper and lower (the direction of arrows U and D in FIG. 3B) end sides of the outer-wall portion 750. The end portions of the upper-wall portion 751 and the lower-wall portion 752 on the inside (arrow R side) in the left-right direction are connected to each other in the up-down direction by the inner-wall portion 753, and the front-end portion (the end portion on the arrow F side in FIG. 3C) of the space surrounded by these wall portions 750 to 753 is blocked by the front-wall portion 754.

The outer-wall portion 750 and the inner-wall portion 753 have rib portions 755 and rib portions 756, respectively, that project toward facing spaces, and the portions 755 and the rib portions 756 are spaced apart in pairs in the up-down direction (see FIG. 3B). The rib portions 755 and 756 are formed like walls that extend in the front-rear direction (the direction of arrows F-B), and the insertion portion 62 is inserted into the facing space between the rib portions 755 and 756. It should be noted that the spacing between the inner-wall portion 753 and the outer-wall portion 750 may be reduced by the rib portions 755 and 756 being omitted, and the insertion portion 62 may be inserted between the wall portions 752 and 753.

When the side finisher 7 is attached to the mounting bracket 6, first, the projecting portion 742 of the guide projection 74 is inserted into the receptacle opening 640 (see FIG. 3A) of the guide hole 64 from the lateral side (the back side in the direction orthogonal to the sheet in FIG. 3A). The portion of the guide hole 64 formed by the receptacle opening 640 and the tapered portion 641 has a substantially trapezoidal shape, and the outer shape (the shape as viewed in the left-right direction) of the projecting portion 742 of the guide projection 74 has a substantially trapezoidal shape that corresponds to the receptacle opening 640 and the tapered portion 641. As a result, it is easily identified that the portion into which the guide projection 74 (projecting portion 742) is inserted is the guide hole 64 (receptacle opening 640).

As illustrated in FIGS. 3 and 4, after the projecting portion 742 is inserted into the receptacle opening 640, the side finisher 7 is slid to the rear side (arrow B side), and accordingly, the base portion 741 of the guide projection 74 is engaged with the engagement portion 642 of the guide hole 64. At this time, since the tapered portion 641 having an opening dimension in the up-down direction gradually reducing toward the rear side is continuous with a portion rearward of the receptacle opening 640, the sliding of the base portion 741 toward the engagement portion 642 can be guided by the tapered portion 641. That is, after the projecting portion 742 is inserted into the receptacle opening 640, the base portion 741 can be engaged with the engagement portion 642 only by the side finisher 7 being simply slid to the rear side. Accordingly, the workability of installation work of the side finisher 7 can be improved.

In addition, the insertion portion 62 of the mounting bracket 6 is inserted into the insertion hole 75 by the side finisher 7 being slid to the rear side. The insertion of the insertion portion 62 is guided by an upper guide wall portion 757, a lower guide wall portion 758, and a lateral guide wall portion 759 (see FIG. 3C for the lateral guide wall portion 759). These guide wall portions 757 to 759 are rib-shaped walls that are formed integrally with the covering portion 70 (insertion hole 75).

The upper guide wall portion 757 and the lower guide wall portion 758 face each other in the up-down direction, and the lower and upper surfaces (the surfaces facing each other) of these upper and lower guide wall portions 757 and 758 are formed as an upper guide surface 757a and a lower guide surface 758a that guide the insertion of the insertion portion 62 into the insertion hole 75.

The facing spacing between the upper guide surface 757a and the lower guide surface 758a in the up-down direction is gradually reduced toward the front side (arrow F side). Although not illustrated, the front end of the upper guide surface 757a is continuous with the lower surface of the upper-wall portion 751 (see FIG. 3B) of the insertion hole 75, and the front end of the lower guide surface 758a is continuous with the upper surface of the lower-wall portion 752 (see FIG. 3B or FIG. 3C). As a result, the insertion of the insertion portion 62 into the insertion hole 75 can be guided by the upper and lower guide surfaces 757a and 758a.

The inner surface (the surface facing the arrow R side) of the lateral guide wall portion 759 (see FIG. 3C) is formed as a lateral guide surface 759a that guides the insertion of the insertion portion 62 into the insertion hole 75. The erect height of the lateral guide wall portion 759 from the covering portion 70 gradually increases toward the front side (arrow F side), and the lateral guide surface 759a is inclined to the inside (arrow R side) in the left-right direction toward the insertion hole 75.

Although not illustrated, a pair of lateral guide wall portions 759 (see FIG. 3C) is spaced apart in the up-down direction, and the insertion of the insertion portion 62 into the insertion hole 75 is guided by this pair of lateral guide wall portions 759. It should be noted that, a step 759b (see FIG. 3) is formed at the boundary between the horizontal guide surface 759a and the side surface of the outer-wall portion 750 (rib portion 755) in the embodiment, but this step 759b may be omitted to smoothly connect the front end of the horizontal guide surface 759a to the side surface of the outer-wall portion 750 (rib portion 755).

As described above, in the embodiment, the guide wall portions 757 to 759 inclined away from the insertion portion 62 toward the rear side are provided, and the insertion of the insertion portion 62 into the insertion hole 75 is guided by the guide surfaces 757a to 759a of these guide wall portions 757 to 759. This can eliminate the work of adjusting the relative position between the insertion portion 62 and the insertion hole 75 when the side finisher 7 is slid to the rear side. That is, after the projecting portion 742 of the guide projection 74 is inserted into the receptacle opening 640 of the guide hole 64, the insertion portion 62 can be inserted into the insertion hole 75 only by the side finisher 7 being slid to the rear side. Accordingly, the workability of installation work of the side finisher 7 can be improved.

In addition, the guide wall portions 757 to 759 that have the guide surfaces 757a to 759a, respectively, are formed in a rib shape that rises from the inner surface of the side finisher 7 (covering portion 70). As a result, the guide wall portions 757 to 759 can have not only the function of guiding the insertion of the insertion portion 62 into the insertion hole 75 but also the function of reinforcing the side finisher 7.

As illustrated in FIG. 4B, the dimension (groove width) of the engagement portion 642 of the guide hole 64 in the up-down direction is the same as or slightly larger than the dimension of the base portion 741 of the guide projection 74 in the up-down direction. Accordingly, the displacement (inclination) of the side finisher 7 in the up-down direction is restricted by the engagement between the engagement portion 642 and the base portion 741 when the base portion 741 is engaged with the engagement portion 642 (at the end position of the slide of the side finisher 7 at which the base portion 741 is in contact with the rear end of the engagement portion 642).

In addition, when the base portion 741 is engaged with the engagement portion 642 (at the end position of the slide of the side finisher 7), the projecting portion 742 that projects vertically from the base portion 741 is engaged with the inner surface of the mounting bracket 6 (that is, the guide projection 74 is engaged with the engagement portion 642). In this state, the displacement of the side finisher 7 in the left-right direction (the direction of arrows L and R) is restricted by the engagement between the projecting portion 742 and the mounting bracket 6 (the edge portion of the engagement portion 642).

In addition, the facing spacing between the upper-wall portion 751 and the lower-wall portion 752 (see FIG. 3B) of the insertion hole 75 and the facing spacing between the outer-wall portion 750 (rib portion 755) and the inner-wall portion 753 (rib portion 756) are also the same as or slightly larger than the dimension in the up-down direction and the dimension in the left-right direction of the insertion portion 62. Accordingly, when the insertion portion 62 is inserted into the insertion hole 75, the displacement of the side finisher 7 in the up-down direction and in the left-right direction is restricted by the engagement therebetween.

That is, at the end position of the slide of the side finisher 7, the movement of the side finisher 7 in directions excluding the front-rear direction is restricted by the insertion portion 62 and the guide projection 74. Since the relative positions between the claws 72 and the fitting holes 73 of the side finisher 7 and the claws 80 and the fitting holes 81 of the inner cover 8 (see FIG. 1) are generally determined in this state, the claws 72 and 80 can be easily fitted to the fitting holes 73 and 81. Accordingly, the workability of installation work of the side finisher 7 can be improved. In addition, since the displacement of the side finisher 7 (the displacement in the up-down direction and in the left-right direction) is restricted by two points that are spaced apart in the front-rear direction, which are the guide projection 74 and the insertion hole 75, the side finisher can be stably fixed to the mounting bracket 6.

In addition, the fitting portions that need to be fitted from the lateral side, such as the claws 72 and 80 and the fitting holes 73 and 81, are not formed on the front side of the guide projection 74 (guide hole 64). Accordingly, the work of fitting the claws 72 and 80 and the fitting holes 73 and 81 together while adjusting the relative positions therebetween only needs to be performed only on the rear side of the guide projection 74. Accordingly, as compared with the case in which, for example, the claws 72 and 80 and the fitting holes 73 and 81 are formed on the front side of the guide projection 74 (guide hole 64), the workability of installation work of the side finisher 7 can be improved.

Here, although the movement of the front-end portion of the side finisher 7 is restricted by the engagement between the insertion portion 62 and the insertion hole 75 in the embodiment, for example, it is possible to form a projection similar to the guide projection 74 on the front-end portion of the side finisher 7 instead of the insertion hole 75 and to form a hole (corresponding to the guide hole 64) into which the projection is inserted, in the mounting bracket 6. However, since a plurality of guide projections 74 need to be formed in the front-rear direction in such a structure, considerable effort is required for the work of adjusting the mounting position (the relative position between the guide holes 64 and the guide projections 74) of the side finisher 7.

In contrast, in this embodiment, the insertion hole 75 is provided on the front side of the guide projection 74, and the movement (displacement in the up-down direction and the left-right direction) of the front-end portion of the side finisher 7 is restricted by the engagement between the insertion hole 75 and the insertion portion 62 of the mounting bracket 6. In the structure as described above, the mounting position of the side finisher 7 with respect to the mounting bracket 6 can be adjusted more easily than the case in which a projection corresponding to the guide projection 74 is provided at the front-end portion of the side finisher 7 instead of the insertion hole 75.

In particular, since one guide projection 74 (guide hole 64) is formed on the side finisher 7 (mounting bracket 6) in the embodiment, the relative position between the guide hole 64 and the guide projection 74 only needs to be adjusted at one position. Accordingly, the projecting portion 742 of the guide projection 74 can be easily inserted into the receptacle opening 640 of the guide hole 64, and accordingly, the workability of installation work of the side finisher 7 can be improved.

In the state in which the side finisher 7 is attached to the mounting bracket 6, when the occupant sits in the vehicle seat 1 or exits from the vehicle, a load from the occupant acts on the side finisher 7. This load bends the side finisher 7 mainly to the outside (arrow L side) in the left-right direction.

When such a load acts on the front-end portion of the side finisher 7, the side finisher 7 is bent toward the arrow L side from the state illustrated in FIG. 3B, and accordingly, the insertion portion 62 is pressed against the inner-wall portion 753 (rib portions 756) of the insertion hole 75 due to this bending. In contrast, the pair of rib portions 756 (see FIG. 3B) arranged in the up-down direction is formed on the inner-wall portion 753, and the rigidity of the inner-wall portion 753 is enhanced by these rib portions 755. This can suppress the insertion hole 75 from being broken by a load from the occupant.

In addition, the rib portions 756 extend in the front-rear direction and couple the inner-wall portion 753 and the front-wall portion 754 to each other (see FIG. 3C), and accordingly, a portion of the load described above can be received by the front-wall portion 754 (the bending of the inner-wall portion 753 due to the load can be restricted by the front-wall portion 754). This can also suppress the insertion hole 75 from being broken.

The load from the occupant described above also acts on the upper surface portion of the side finisher 7, and this load becomes a load that bends the side finisher 7 mainly to the lateral downside (a load that spreads the side finisher 7 in a direction between arrow L and arrow D in FIG. 4B). In contrast, since the projecting portion 742 of the side finisher 7 extends upward from the base portion 741, the upper surface portion of the side finisher 7 can be effectively restricted from spreading by the projecting portion 742 as compared with the structure in which, for example, the projecting portion 742 projects to only the rear side (or only the downside) from the base portion 741. Accordingly, the side finisher 7 can be stably fixed to the mounting bracket 6.

In addition, the projecting portion 742 also projects to the rear side from the base portion 741 (see FIG. 4A), and the outer shape of the portion that projects to the rear side corresponds to the shape of the receptacle opening 640 and the tapered portion 641 (the projecting portion 742 has a substantially trapezoidal shape as a whole). As a result, it is possible to form the projecting portion 742 in a shape that can be inserted into the guide hole 64 (the receptacle opening 640 and the tapered portion 641) while increasing the amount of projection of the projecting portion 742 toward the rear side.

The increasing in the amount of projection of the projecting portion 742 toward the rear side can improve the bending strength of the projecting portion 742 with respect to the base portion 741 as compared to the structure in which, for example, the projecting portion 742 projects only upward from the base portion 741. Accordingly, even when a load from the occupant repeatedly acts on the upper surface portion of the side finisher 7, the guide projection 74 (projecting portion 742) can suppressed from being broken.

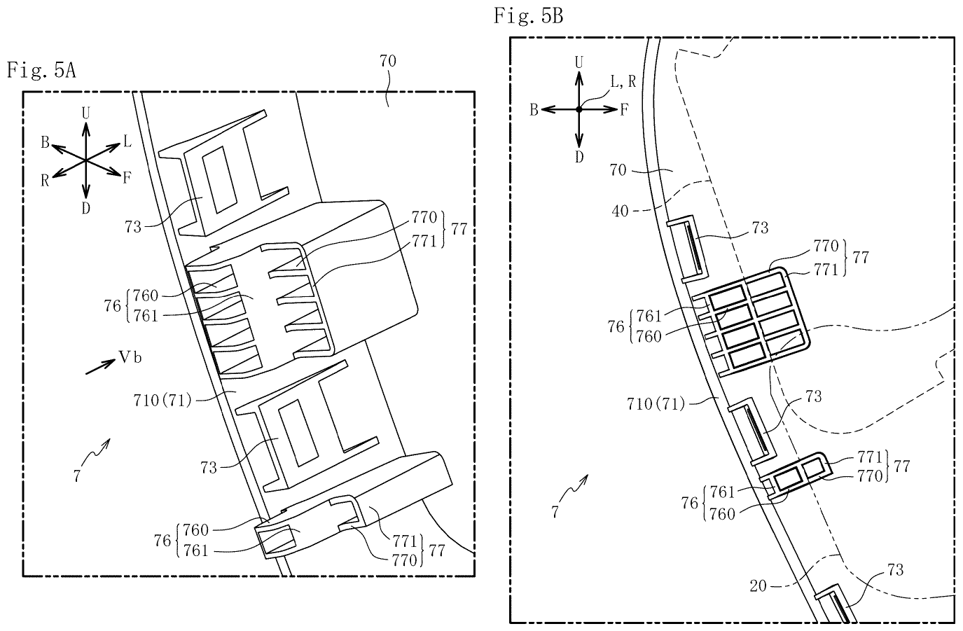

Here, the load acts on the side finisher 7 not only from the occupant sitting in the vehicle seat 1 but also from the occupant sitting in the rear seat of the vehicle seat 1. When the load from the rear side acts on the outer peripheral portion 71 of the side finisher 7 (see FIG. 2), the side finisher 7 may be detached from the inner cover 8 (see FIG. 1) or the side finisher 7 may be broken. This structure for suppressing the side finisher 7 from being detached or broken will be described with reference to FIG. 5.

FIG. 5A is a perspective view of the side finisher 7, illustrating portion Va in FIG. 2 in an enlarged manner, and FIG. 5B is a side view of the side finisher 7 as viewed in the direction of arrow Vb in FIG. 5A. It should be noted that FIG. 5B illustrates the side frame 20 with a dot-dot-dash line and the bracket 40 of the reclining device 4 with a dotted line among the components disposed in the side finisher 7.

As illustrated in FIG. 5, of the outer peripheral portion 71 of the side finisher 7, the portion that covers the side frame 20 and the bracket 40 of the reclining device 4 (referred to below as the other components 20 and 40) from the rear side is indicated and described as a back surface portion 710. The back surface portion 710 overlaps the side frame 20 and the reclining device 4 (bracket 40) as viewed in the front-rear direction.

A gap is formed between the back surface portion 710 and the other components 20 and 40. In addition, although not illustrated, a gap is also formed between the covering portion 70 and the other components 20 and 40. The back surface portion 710 (the covering portion 70 and the outer peripheral portion 71) of the side finisher 7 is formed integrally with a rear restricting wall 76 and a side restricting wall 77 that fill these gaps.

These restricting walls 76 and 77 include flat horizontal ribs 760 and 770 that extend from the back surface portion 710 toward the other components 20 and 40 (toward the front side), and flat vertical ribs 761 and 771 that extend in the up-down direction (in the extension direction of the back surface portion 710), respectively. The restricting walls 76 and 77 are substantially rectangular-shaped walls (raised portions projecting from the back surface portion 710 toward the front side) formed by combining the plurality of horizontal ribs 760 and 770 arranged in the up-down direction with the plurality of vertical ribs 761 and 771 arranged in the left-right direction (the direction orthogonal to the extension direction of the back surface portion 710).

The erect height of the rear restricting wall 76 from the covering portion 70 is greater than the erect height of the side restricting wall 77, the rear restricting wall 76 is disposed between the back surface portion 710 and the other components 20 and 40, and the side restricting wall 77 is disposed between the covering portion 70 and the other components 20 and 40.

As a result, even when a load from an occupant sitting in the rear seat behind the vehicle seat 1 acts on the side finisher 7, the movement of the side finisher 7 toward the front side and the deformation of the side finisher 7 (for example, the back surface portion 710) toward the other components 20 and 40 can be restricted by the contact between the respective restricting walls 76 and 77 and the other components 20 and 40. Accordingly, the detachment of the side finisher 7 from the inner cover 8 (see FIG. 1) or the breakage of the side finisher 7 (for example, the back surface portion 710) can be suppressed.

Here, some of the plurality of fitting holes 73 into which the claws 80 of the inner cover 8 (see FIG. 1) described above are fitted are formed integrally with the back surface portion 710. Accordingly, for example, the height (the amount of projection toward the front side) of the fitting holes 73 that rises from the back surface portion 710 can be adjusted to fill the gap between the back surface portion 710 and the other components 20 and 40 with the fitting holes 73. However, in the structure as described above, the fitting holes 73 collide with the other components 20 and 40 when a load from the rear side acts on the side finisher 7, and accordingly, the claws 80 of the inner cover 8 (see FIG. 1) are likely to disengage from the fitting holes 73 or the claws 80 are likely to be broken.

In contrast, since the restricting walls 76 and 77 are formed between the plurality of fitting holes 73 arranged along the back surface portion 710 in the embodiment, even when a load from the rear side acts on the side finisher 7, the restricting walls 76 and 77 can restrict this load from being applied to the fitting portions between the fitting holes 73 and the claws 80 or can restrict contact between the fitting holes 73 and other components 20 and 40. This can suppress the detachment of the claws 80 from the fitting holes 73 or the breakage of the claws 80.

The present invention has been described based on the embodiment described above, but it is easy to infer that the present invention is not limited to the embodiment described above and various modifications and improvements can be made without departing from the spirit of the present invention.

The case in which the insertion portion 62 and the guide hole 64 are formed in the mounting bracket 6, which is a separate member from the side frame 20, has been described in the embodiment described above, but the present invention is not necessarily limited to this example. For example, either the insertion portion 62 or the guide hole 64 may be formed in the side frame 20, or both the insertion portion 62 and the guide hole 64 may be formed in the side frame 20 while the mounting bracket 6 is omitted.

The case in which the insertion hole 75 is formed on the front side of the guide projection 74 has been described in the embodiment described above, but the present invention is not necessarily limited to this example. For example, a projection similar to the guide projection 74 may be formed on the front-end portion of the side finisher 7 while the insertion hole 75 is omitted, and a hole with which this projection (corresponding to the guide hole 64) is engaged may be formed in the mounting bracket 6.

In addition, while the insertion hole 75 is not omitted, a projection similar to the guide projection 74 may also be separately formed on the front side (between the guide projection 74 and the insertion hole 75) of the guide projection 74 or on the rear side (between the claw 72 located on the frontmost side and the guide projection 74) of the guide projection 74. In addition, the guide projection 74 may be formed on the front-end portion of the side finisher 7 while the insertion hole 75 is formed on the rear side of the guide projection 74. That is, the number and the arrangement of guide projections 74 and insertion holes 75 can be changed as appropriate, and the insertion portions 62 and the guide holes 64 only need to be formed at positions corresponding to the number and the arrangement.

The case in which the upper guide wall portion 757, the lower guide wall portion 758, and the lateral guide wall portion 759 that guide the insertion of the insertion portion 62 into the insertion hole 75 are formed has been described in the embodiment described above, but some or all of these wall portions 757 to 759 may be omitted.

The case in which the guide hole 64 is formed by the receptacle opening 640, the tapered portion 641, and the engagement portion 642 has been described in the embodiment described above, but, for example, the tapered portion 641 may be omitted. In addition, the case in which the front-end portion of the guide hole 64 (receptacle opening 640) is blocked has been described, but the front-end portion may also be left open.

The case in which the projecting portion 742 of the guide projection 74 projects in the upward direction and in the rearward direction from the base portion 741 has been described in the embodiment described above, but the present invention is not necessarily limited to this example. For example, the projecting portion 742 may project in any one of the upward, rearward, and downward directions, or the projecting portion 742 may project in any two of the upward, rearward, and downward directions. In addition, the projecting portion 742 may project in the upward, rearward, and downward directions from the base portion 741 or the projecting portion 742 may be omitted.

The case in which the outer shape of the projecting portion 742 is a trapezoidal shape corresponding to the receptacle opening 640 and the tapered portion 641 has been described in the embodiment described above, but the outer shape of the projecting portion 742 may also be a shape (for example, a circle, a square, a rectangle, another polygon, or a combination of these shapes) different from that of the receptacle opening 640 and the tapered portion 641.

The case in which the rear restricting wall 76 and the side restricting wall 77 that restrict the deformation of the side finisher 7 toward the other components 20 and 40 has been described in the embodiment described above, but either or both of these restricting walls 76 and 77 may be omitted, or walls corresponding to the restricting walls 76 and 77 may be separately formed in other portions of the side finisher 7.

### DESCRIPTION OF REFERENCE NUMERALS

1 vehicle seat
2 cushion frame
20 side frame (other component)
40 bracket (other component)
6 mounting bracket
62 insertion portion
64 guide hole
640 receptacle opening
641 tapered portion
642 engagement portion
7 side finisher
70 covering portion
71 outer peripheral portion
710 back surface portion
72 claw (fitting portion)
73 fitting hole (fitting portion)
74 guide projection
741 base portion
742 projecting portion
75 insertion hole
750 outer-wall portion
751 upper-wall portion
752 lower-wall portion
753 inner-wall portion
754 front-wall portion
756 rib portion
757 upper guide wall portion (guide wall portion)
758 lower guide wall portion (guide wall portion)
759 lateral guide wall portion (guide wall portion)
76 rear restricting wall (restricting wall)
77 side restricting wall (restricting wall)
80 claw (fitting portion)
81 fitting hole (fitting portion)

What is claimed is:

1. A vehicle seat comprising:
a side frame, provided in a cushion frame, that extends in a front-rear direction; and
a side finisher that covers a side surface of the side frame,
wherein a side closer to the side frame includes a fitting portion, the side finisher includes a fitting portion, and the fitting portions are fitted to each other by the side finisher being pushed from a lateral side,
the side closer to the side frame has a guide hole on a front side of the fitting portion,
the side finisher includes a guide projection fitted to the guide hole in a slidable manner from the front side,
displacement of the side finisher in an up-down direction and in a left-right direction is restricted with the guide projection engaged with the guide hole, and
the fitting portion is not formed on the front side of the guide projection.

2. The vehicle seat according to claim 1,
wherein an insertion portion that projects toward the front side is formed on the side closer to the side frame,
the side finisher has an insertion hole, formed on the front side of the guide projection, that has an opening on a rear side into which the insertion portion is inserted, and
the displacement of the side finisher in the up-down direction and in the left-right direction is restricted with the insertion portion inserted into the insertion hole.

3. The vehicle seat according to claim 2,
wherein the side finisher includes a guide wall portion, formed in a rib shape extending rearward from a rear end portion of the insertion hole, that is inclined away from the insertion portion toward the rear side.

4. The vehicle seat according to claim 1,
wherein the guide hole has a receptacle opening that is larger than an outer shape of the guide projection, a tapered portion, continuous with a portion rearward of the receptacle opening, that has an opening dimension in the up-down direction gradually reducing toward the rear side, and an engagement portion, continuous with a portion rearward of the tapered portion, with which the guide projection is engaged.

5. The vehicle seat according to claim 4,
wherein the guide projection includes a base portion to be engaged with the engagement portion and a projecting portion that projects upward from an end portion of the base portion on an inside in the left-right direction, and
displacement of the side finisher toward an outside in the left-right direction is restricted by the projecting portion.

6. The vehicle seat according to claim 5,
wherein the projecting portion projects upward and rearward from an end portion of the base portion on the inside in the left-right direction, and
an outer shape of the projecting portion corresponds to the receptacle opening and the tapered portion.

7. The vehicle seat according to claim 1,
wherein the side finisher includes a covering portion that covers a side surface of the side frame and an outer peripheral portion that rises from an outer edge of the covering portion toward the side closer to the side frame,
the outer peripheral portion includes a back surface portion that covers, from a rear side, another component disposed inside the side frame, and
a restricting wall that restricts deformation of the side finisher toward the other component is formed on the back surface portion.

8. The vehicle seat according to claim 7,
wherein the side finisher includes a plurality of fitting portions arranged along the back surface portion and the restricting wall formed between the plurality of the fitting portions, the fitting portion being one of the plurality of fitting portions.

9. The vehicle seat according to claim 2,
wherein the insertion hole has an outer-wall portion formed on a side surface of the side finisher on an inside in the left-right direction, an upper-wall portion and a lower-wall portion that project to the inside in the left-right direction from both ends of the outer-wall portion in the up-down direction, and an inner-wall portion that connects, in the up-down direction, end portions of the upper-wall portion and the lower-wall portion on the inside in the left-right direction,
a plurality of rib portion that project toward the outer-wall portion are formed on the inner-wall portion, and
the plurality of rib portions are formed like walls that extend in the front-rear direction and arranged in the up-down direction.

10. The vehicle seat according to claim 9,
wherein the insertion hole has a front-wall portion that blocks a front-end portion of a space surrounded by the outer-wall portion, the upper-wall portion, the lower-wall portion, and the inner-wall portion, and
the rib portions couple the inner-wall portion and the front-wall portion to each other.
